(19) United States
(12) Patent Application Publication
(10) Pub. No.: US 2010/0236771 A1
(43) Pub. Date: Sep. 23, 2010

(54) Heating plate and method for manufacturing it

(76) Inventor: David Sanchez Duque, Caceres (ES)

Correspondence Address: COLLARD & ROE, P.C., 1077 NORTHERN BOULEVARD, ROSLYN, NY, 11576, US

(21) Appl. No.: 12/308,426

(22) PCT Filed: Jun. 16, 2006
(86) PCT No.: PCT/ES2006/000355

§ 371 Date: Dec. 15, 2008

(51) Int. Cl. G05D 23/01; F28F 7/00; B21D 53/02

(52) U.S. Cl. 165/287; 165/185; 29/890.03

(57) ABSTRACT

The object of the present invention is a high-performance heating plate and also the method for manufacturing said plate. The heating plate is composed of two basic plate elements, each basic plate being composed, in turn, of a non-electrically-conducting plate on whose surface there is a resistive circuit for the purpose of establishing a surface for dissipation of the energy lost by the passage of the current through the resistive circuit. It is characterized in that, on the basic plate of this invention, use is made of conducting strips supplying power to the resistive surface and configured by means of spraying molten metal. The method that allows production of the plate of this invention makes use of electric-arc metal spraying machines.

### OBJECT OF THE INVENTION

The object of the present invention is a high-performance heating plate and also the method for manufacturing said plate.

The heating plate is composed of two basic plate elements, each basic plate being composed, in turn, of a non-electrically-conducting plate on whose surface there is a resistive circuit for the purpose of establishing a region of dissipation of the energy lost by the passage of the current through the resistive circuit.

It is characterized in that, on the basic plate of this invention, use is made of conducting strips supplying electric power to the resistive surface and configured by means of spraying molten metal.

The method that allows the production of the plate of this invention makes use of electric-arc molten metal spraying machines.

The plate of the invention allows the construction of heaters from which an example will be indicated.

### BACKGROUND OF THE INVENTION

There are configurations of heating plates in which use is made of one or more power supply metal tracks, preferably made of copper, located on a mica plate on which strips of conducting paint are applied.

When it is stated that the paint is conducting it is because it has a certain degree of resistance to the passage of the current such that the product of the resistance by the square of the effective intensity is equal to the dissipated power.

The reduction of the section of the conducting paint because the applied layer is smaller or because the painted width is smaller gives rise, before the same passage of current, to a higher dissipated power because the resistance is increased.

This paint must be applied between two power supply conducting strips so that the passage of the current occurs through the entire conducting paint.

It is important for the contact with the power supply tracks to be suitable.

The conducting tracks of the state of the art mainly consist of copper tracks which are adhered on the insulating plate, made of mica, for example.

A smooth copper tracks gives rise to a poor adherence of the conducting paint which tends to retract before drying on the metal surface, establishing a poor power supply contact.

This problem has been partly solved in the state of the art by searching for varnishes or other substances which are added in a third layer and which are useful as an interface between the conducting strip and the conducting paint. Some of these varnishes or substances are mixed with the same conducting paint to achieve the suitable degree of contact between the conducting strip and the conducting paint.

In any case, it is necessary to apply a third strip preventing the problem of the poor attachment between the conducting track and the conducting paint.

An object of this invention is to establish a manufacturing method which allows the suitable attachment between the conducting power supply metal strip and the conducting paint acting as a resistive element.

### DESCRIPTION OF THE INVENTION

The essence of the invention consists of a heating plate formed in turn by two basic two plates.

Each of the basic plates is formed by a plate which does not conduct electricity which is useful as a resistant support. The material which is preferably used is mica or natural stone.

The resistive component which will be used is a conducting paint which offers a certain degree of resistance such that the passage of the current through the painted strip dissipates energy in the form of heat, achieving the desired effect: heat generation.

The electric power supply of the strip painted with conducting paint by means of two metal tracks between which said conducting paint is placed. These metal tracks polarize and supply power to the conducting paint.

The essence of the invention is in the application of the conducting metal strips and the attachment with the conducting paint.

The metal strips are sprayed by means of arc molten metal spraying heads. These spraying heads are usually used for coating surfaces requiring protection against corrosion, for example.

The heads have a power supply of two metal wires converging at a point at which they come into contact. Given that the metal wires are supplied with electric power, when they come into contact an electric arc is established which melts both wires at said point of contact.

The melting occurs continuously because the wires are supplied with power at a certain speed.

Due to the action of a gas under pressure impinging on the point at which the electric arc occurs, the molten metal is sprayed in drops towards the surface which is opposite the head and in the blowing direction.

The use, for example, of different metals in each of the metal wires gives rise to very clean alloys. For its part, the use of suitably chosen spraying gases also establishes a controlled atmosphere.

The molten metal sprayed on the surface of the mica, the material preferably used in the embodiments of the invention, is closely attached to said surface, giving rise to a certain degree of surface irregularity, such as waviness.

These surface irregularities of the metal tracks favor the attachment with the conducting paint.

The conducting paint is subsequently applied on the plate between the two tracks and is partially or completely superimposed on the sprayed metal tracks.

The roughness of the surface of the metal tracks makes it difficult for the surface tension effect to remove the paint applied on the metal surface. Better results are obtained in this application if the paint is also incorporated by spraying.

The method for obtaining the basic plate is completed by introducing this plate in an oven at 200 degrees, giving rise to a petrifying phase such that all the applied components form a single body.

This plate with the petrified paint can be drilled allowing its application and attachment to other elements with a decorative result, for example.

To prevent the exposure of the parts which are polarized and with passage of current, two basic plates are superimposed, forming a single plate with a stratified or sandwich structure.

The sprayed power supply metal tracks extend to a side of the plate for supplying power from a power supply connector.

The plate thus manufactured and configured is an object of the invention.

The essential technical features defining it can be expressed by indicating that this plate is formed by the attachment of two basic plates with printed elements for generating heat by resistive dissipation. Each of these basic plates is formed by a non-electrically-conducting plate on which there are defined at least two electric power supply metal tracks incorporated by electric-arc spraying between which there is arranged an area of conducting paint, forming the region of dissipation. It is understood that the indication that the track is configured by means of electric-arc spraying is the best way to establish its configuration on the substrate to which it is incorporated.

This plate can be used to construct an electric power supply heater. The heater must have the power supply connecting with the terminals of the plate used, and also the protection means so that, if possible, it cannot de directly accessed by the user in order to prevent accidents.

A low-consumption heater making use of two plates such as those of the invention is especially interesting. A front plate and another inner plate which cannot be accessed due to presence of the former. A separation is established between both plates which gives rise to an air chamber favoring natural convection.

The strategy used in the design to favor low consumption consists of making use of two independent thermostats, one for each of the plates, one thermostat regulating the temperature of the rear plate and the other one for the front plate.

The front plate must not reach temperatures greater than 60 or 65 degrees centigrade to prevent an accidental contact with the user from giving rise to serious burns. The rear plate can reach higher temperatures.

Thus, when the heating is cold and is turned on, the two plates connect, quickly reaching the operating temperature. Once this temperature is reached, given that the rear plate can be placed at higher values, it maintains the temperature of the front plate by radiation. This radiation allows, on one hand, the front plate to remain off most of the time because its temperature does not decrease and, on the other hand, to achieve the heating by natural convection of the mass of air located between both plates.

It is possible to incorporate an additional condition for disconnecting the power supply into this scheme of operation, and such condition is that the front plate, even disconnected, has a temperature exceeding a certain safety value heated by the rear plate. In this case, the rear plate would also be turned off, reducing even more the consumption and maintaining the safety of the user. An embodiment of this heater will be described in the section dedicated to the detailed description of the invention.

### DESCRIPTION OF THE DRAWINGS

The present specification is complemented with a set of drawings which illustrate the preferred example and never limit the invention.

FIG. 1 is a schematic representation of an electric-arc spraying head.

FIG. 2 is an embodiment of a basic plate with which the heating plate is configured.

FIG. 3 is a detail of the sectioned basic plate in which the attachment between the conducting paint and the electric power supply metal strip.

FIG. 4 is a schematic embodiment of a heater shown in a plan and elevational view, making use of two plates such as those described in the previous examples.

### DETAILED DESCRIPTION OF THE INVENTION

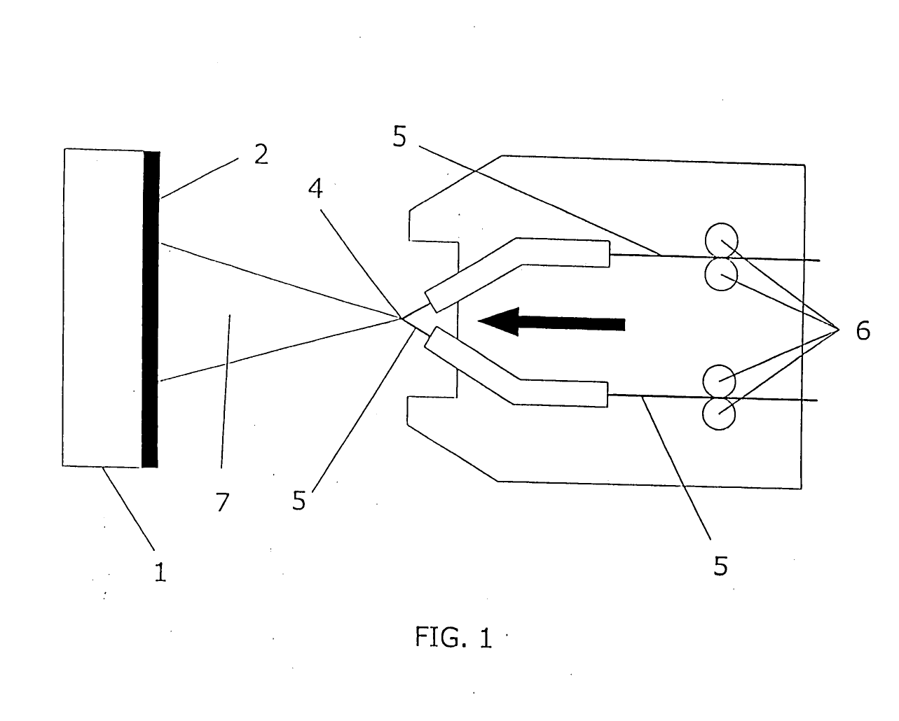

FIG. 1 shows an arc spraying head such as the one which will be used in the method for manufacturing the heating plate of the invention.

This head comprises a pair of metal wires (5) driven by rollers (6) for the continuous power supply of the head.

Both wires (5) converge at a common point (4). Given that the wires (5) are supplied with power with a potential difference that is sufficient for an electric arc to be established, both metals melt.

Both wires (5) converge at a common point (4). Given that the wires (5) are supplied with power with a potential difference that is sufficient for an electric arc to be established, both metals melt.

In this embodiment an aluminium wire (5) and another zinc wire will be used to give rise to an aluminium and zinc alloy. The blowing direction which breaks up the molten metal into small drops is indicated by means of a thick arrow, which drops are sprayed in a cone (7) giving rise to the adhesion of these drops on the surface (1) on which it impinges until forming a metal layer (2).

In this invention the substrate is a mica plate (1) and the metal layer (2) will form the metal track supplying current to the conducting paint (3).

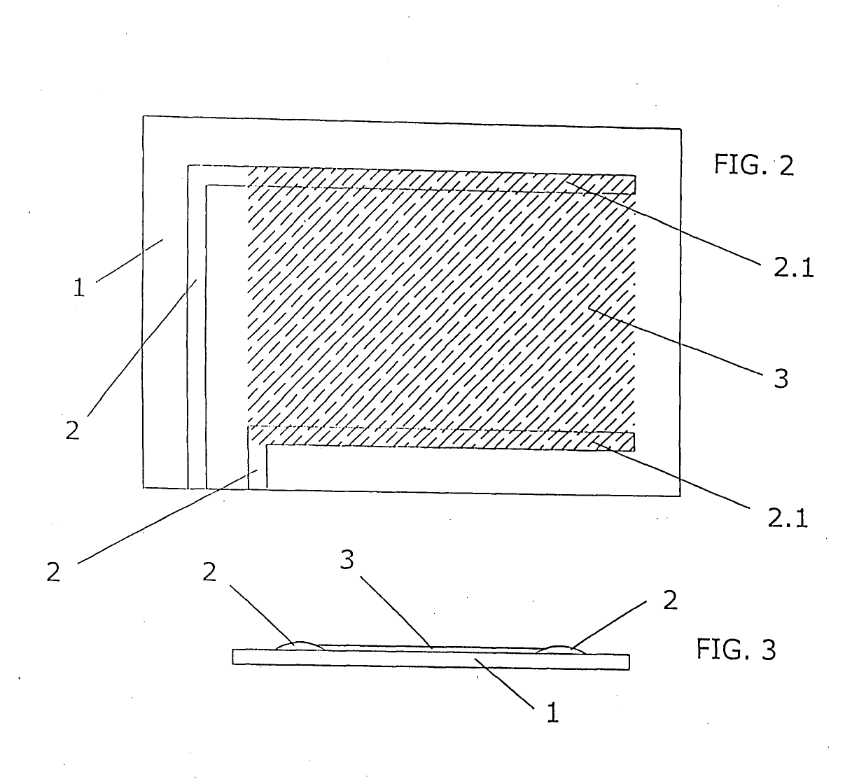

FIG. 2 shows the basic plate which will form the heating plate on which two metal tracks (2) have been sprayed by means of the arc spraying heads.

These tracks (2) have been configured in an L-shape to achieve that their ends reach the edge of the basic plate (1) and can be easily connected to a connector (not shown) supplying electric power to the plate (1).

On the metal tracks (2) there is a shaded area showing the region on which the conducting paint (3) forming the heat generation area is applied.

This shaded area corresponding to the conducting paint (3) is superimposed on part of the area occupied by the metal tracks (2) to achieve the suitable contact between both.

FIG. 3 shows the attachment between the conducting paint (3) and the metal track (2) without the paint completely covering said metal track (2). The interest of this graphic representation is showing the suitable “wetting” of the paint favored by the roughness of the metal projection preventing the removal of the paint when it is still not dry.

The paint attempts to cover the area due to the tendency for self-leveling which it has upon covering this area between the elevations forming the metal projections (2).

This configuration of the basic plate is therefore obtained through the following steps:
Spraying the metal strips (2) by means of the electric-arc head by melting two metal wires (5).
Painting an area between two power supply metal strips (2).
Baking the resulting plate for the petrification of the assembly.
Attaching two basic plates thus formed, internally leaving the printed area to form a heating plate.

Once the plate is formed by the attachment of these basic plates (1), the connectors are incorporated to the prolongations of the metal tracks (2) for the suitable power supply.

The plates thus configured can be drilled and incorporated inside a heating device.

These same boreholes allow incorporating decorative elements or the support means for their operational use.

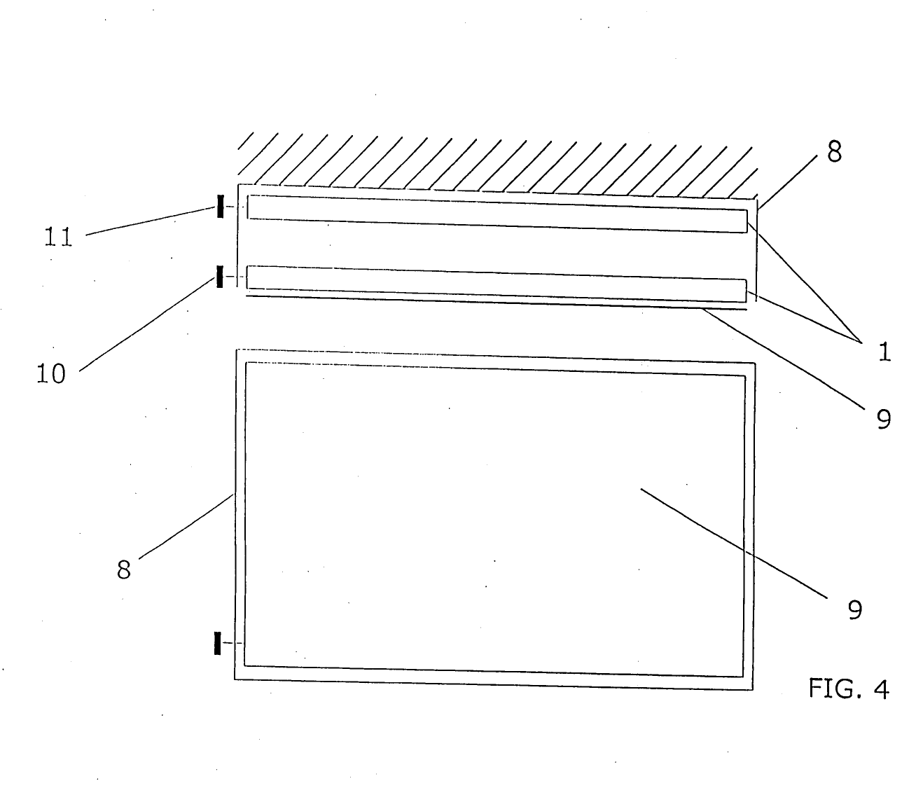

An example of use of this heating plate (1) is shown in FIG. 4. This figure shows an elevational and upper plan view according to a scheme of distribution of elements.

The heater constructed making use of the plates (1) has a casing (8) housing two plates (1), a front plate and another rear plate.

The front plate (1) can either be directly accessed by the user or is protected by a decorative front element (9). In any case, this front plate (1) is the one closest to the user and is suitable for reaching temperatures limited by low values such as 60 or 65 degrees centigrade, for example.

In contrast, the rear plate (1) is more protected and it is possible for it to reach higher temperatures. The separation between one plate (1) and the other plate (1) establishes an air chamber which is heated, giving rise to an air current moving by natural convection in an upward direction. The heater thus carries out a heating by a dual effect: by radiation and by natural convection.

To achieve the objective that the front plate (1) does not exceed the indicated safety temperature values, it has a thermostat (10) disconnecting the plate (1) once it reaches said temperature.

The rear plate (1) also has a thermostat (11) limiting the operational temperature and which will be located above the temperature of the front plate (1).

Once the front plate (1) reaches the operational temperature, the latter will be maintained for much more time by the heating by radiation of the rear plate (1). It will only be connected again if the cooling by the inner convection current and the heat radiation cools it excessively. Given that for most of the time only one plate (1) is turned on, the consumption is significantly reduced.

The rear plate (1) will also depend on the thermostat (10) of the front plate (1) so that if its temperature still very high, it is also disconnected.

The location of the wall with respect to the heater is indicated by means of a shading located after the casing (5)

Although the thermostats (10, 11) have been located outside the casing (8), their location is only a schematic representation indicating their presence, being able to be located at any point giving rise to a suitable reading of the temperature.

1. A heating plate formed by the attachment of two basic plates with printed elements for generating heat by resistive dissipation, wherein each of these basic plates is formed by a non-electrically-conducting plate (1) on which there are defined at least two power supply metal tracks (2) incorporated by electric-arc spraying between which there is arranged an area of conducting paint (3) forming the region of dissipation.

2. The heating plate according to claim 1, wherein the basic plate makes use of natural stone or mica as a non-electrically-conducting plate.

3. The heating plate according to claim 1, wherein the metal tracks (2) are made of an aluminium and zinc alloy.

4. The heating plate according to claim 1, wherein the conducting paint (3) completely covers the width of the power supply metal track (2).

5. The heating plate according to claim 1, wherein the conducting paint (3) partially covers the width of the power supply metal track (2).

6. The heating plate according to claim 1, wherein the paint (3) is petrified by baking.

7. A heater formed by a plate according to claim 1, wherein it is formed by two heating plates (1), a front plate and another rear plate, leaving an intermediate chamber such that each of them has its independent thermostat (10, 11).

8. The heater according to claim 7, wherein the thermostat (10) of the front plate (1) is set to a temperature lower than the thermostat (11) of the rear plate such that the temperature of the front plate (1) can be maintained by the radiation heat of the rear plate (1).

9. The heater according to claim 8, wherein the thermostat (11) of the rear plate (1) is also disconnected when the front plate (1) exceeds a certain predetermined value.

10. A method for manufacturing a heating plate formed by the following steps:
spraying the metal strips (2) by means of an electric-arc head by the melting of two metal wires (5),
painting an area between the two power supply metal strips (2),
baking the resulting plate for the petrification of the assembly,
attaching two basic plates thus formed, internally leaving the printed are to form the heating plate.

11. The method for manufacturing a heating plate according to claim 10, wherein the area between the two metal strips (2) by means of conducting paint (3) is painted by spraying.
